(19) United States
(12) Patent Application Publication
(10) Pub. No.: US 2018/0210721 A1
(43) Pub. Date: Jul. 26, 2018

(54) PROCESSING APPARATUS, INFORMATION PROCESSING APPARATUS AND PROCESSING SYSTEM

(71) Applicant: FUJI XEROX CO., LTD., Tokyo (JP)

(72) Inventor: Atsuya BABA, Kanagawa (JP)

(73) Assignee: FUJI XEROX CO., LTD., Tokyo (JP)

(21) Appl. No.: 15/688,044

(22) Filed: Aug. 28, 2017

(30) Foreign Application Priority Data
Jan. 24, 2017 (JP) 2017-009990

(51) Int. Cl. G06F 9/445

(52) U.S. Cl. CPC G06F 8/65; H04L 41/046; G06F 9/44505

(57) ABSTRACT

A processing apparatus includes a presentation unit that presents an indication that a reboot is to be performed when information indicating a right to reboot is received via a communication network if the processing apparatus is to be rebooted to reflect a setting of a value in a setting item on the processing apparatus.

### CROSS-REFERENCE TO RELATED APPLICATIONS

This application is based on and claims priority under 35 USC 119 from Japanese Patent Application No. 2017-009990 filed Jan. 24, 2017.

### BACKGROUND

### (i) Technical Field

The present invention relates to a processing apparatus, an information processing apparatus and a processing system.

### (ii) Related Art

A value is set in a setting item of a processing apparatus via a communication network. To reflect a setting, the setting item thereof may involve rebooting the processing apparatus. For example, while the value is being set in the setting item, an event may occur. That event may present difficulty in issuing an instruction to reboot the processing apparatus to reflect the value in the setting item on the processing apparatus. The setting is not reflected in this case, leading to an unstable state on the processing apparatus. A user is unable to recognize that the processing apparatus is to be rebooted.

### SUMMARY

According to an aspect of the invention, there is provided a circuit including a processing apparatus. The processing apparatus includes a presentation unit that presents an indication that a reboot is to be performed when information indicating a right to reboot is received via a communication network if the processing apparatus is to be rebooted to reflect a setting of a value in a setting item on the processing apparatus.

### BRIEF DESCRIPTION OF THE DRAWINGS

Exemplary embodiment of the present invention will be described in detail based on the following figures, wherein:

FIG. 1 illustrates a module concept of an exemplary embodiment;

FIG. 2 illustrates a system configuration of the exemplary embodiment;

FIG. 3 is a flowchart illustrating a process example of the exemplary embodiment;

FIG. 4 illustrates a presentation example on a setting screen of the exemplary embodiment;

FIG. 5A and FIG. 5B illustrate data structures of exclusive setting right ID management tables;

FIG. 6 is a flowchart illustrating a process example of the exemplary embodiment;

FIG. 7 illustrates a presentation example of the screen of the exemplary embodiment;

FIG. 8 is a flowchart illustrating a process example of the exemplary embodiment;

FIG. 9 is a flowchart illustrating a process example of the exemplary embodiment;

FIG. 10 illustrates an example of a data structure in the exclusive setting right ID management table; and

FIG. 11 is a block diagram illustrating a hardware configuration of a computer that implements the exemplary embodiment.

### DETAILED DESCRIPTION

The premise for an exemplary embodiment and an image processing apparatus based on the exemplary embodiment are described below before describing the exemplary embodiment. The following discussion is useful for the understanding of the exemplary embodiment.

Some of image processing apparatuses available today having functionalities of a printer, a facsimile machine, a copying machine, and the like, provide a device status, information of stored documents, and information of spooled jobs on a web page on a terminal or the like connected to a communication network (including a communication line).

Also, some of the image processing apparatuses enable values to be set in a variety of setting items (also referred to as parameters) using a web page displayed on a web browser of a terminal or the like connected thereto via a communication network. Since the image processing apparatus provides a setting unit for setting the setting items using the web page, a user may remotely operate a device or set the setting items.

Depending on the setting item, an updated value may not be reflected on the image processing apparatus without rebooting the image processing apparatus. The reboot operation is also referred to as a restart, and may be a hard reboot (cold reboot) or a soft reboot (warm reboot). In the related art, after remotely updating a value in a setting item on an image processing apparatus, a user goes close to the image processing apparatus and performs an operation, such as pressing a reset button on the image processing apparatus. The benefit of remote control is not fully enjoyed.

Without restarting the image processing apparatus, a determination as to whether an updated value is a value that is to be reflected in the operation of the image processing apparatus is not performed, and a reboot instruction is not transmitted from a user interface (UI) of a remote terminal.

In one related art technique, a determination as to whether to reboot is made in response to a setting item having a value whose updating is requested. If a reboot is determined to be performed, an electronic device (corresponding to the image processing apparatus) is rebooted. If an update request is made to update a single setting item that is determined to be rebooted, the electronic device is definitely rebooted. To set plural setting items, plural reboots may be performed.

In the related art, for example, update requests to update values that involve rebooting may be made to update parameters related to plural reboots. In such a case, a screen display indicating the necessity of rebooting is displayed. For example, the screen display presents a message “Reboot now”, or “Reboot later”.

If the message “Reboot later” is selected, a screen operation may be continuously performed, and a reboot operation may be started after all related setting is complete.

In such a case, a value whose updating is not reflected in the operation of the image processing apparatus without a restart is determined to be of the type that involves the rebooting, and setting items involving plural reboots are enabled to undergo the setting at a time. The timing of reboot is when the “Reboot now” is selected on the UI of the remote terminal. The image processing apparatus is thus unable to determine the timing of the reboot.

If the communication network is disconnected in the middle of the setting on the UI of the remote terminal, the remote terminal is unable to send a reboot instruction to the image processing apparatus. The image processing apparatus is updated in the setting item but is unstable because it is not rebooted. It is not verified that the image processing apparatus has undergone the reboot. Although the reboot instruction is transmitted from the remote terminal to the image processing apparatus, but may not be carried out at the image processing apparatus because of a malfunction, such as a disconnection of the communication network. The image processing apparatus does not recognize the necessity of reboot.

In the following two cases, the image processing apparatus is unstable because rebooting is not performed.

Case a. (1) Setting items whose rebooting is desired are changed, (2) Setting items whose rebooting is not desired are changed, and then (3) The communication network is disconnected because of a communication malfunction. In this case, the number of reboot operations desired is one reboot operation only, but the image processing apparatus is not rebooted and is unstable.
Case b. Although setting items whose rebooting is desired are changed, a person who has changed setting items may forget to reboot. The image processing apparatus is not rebooted, and is thus unstable.

An exemplary embodiment of the present invention is described below with reference to the drawings.

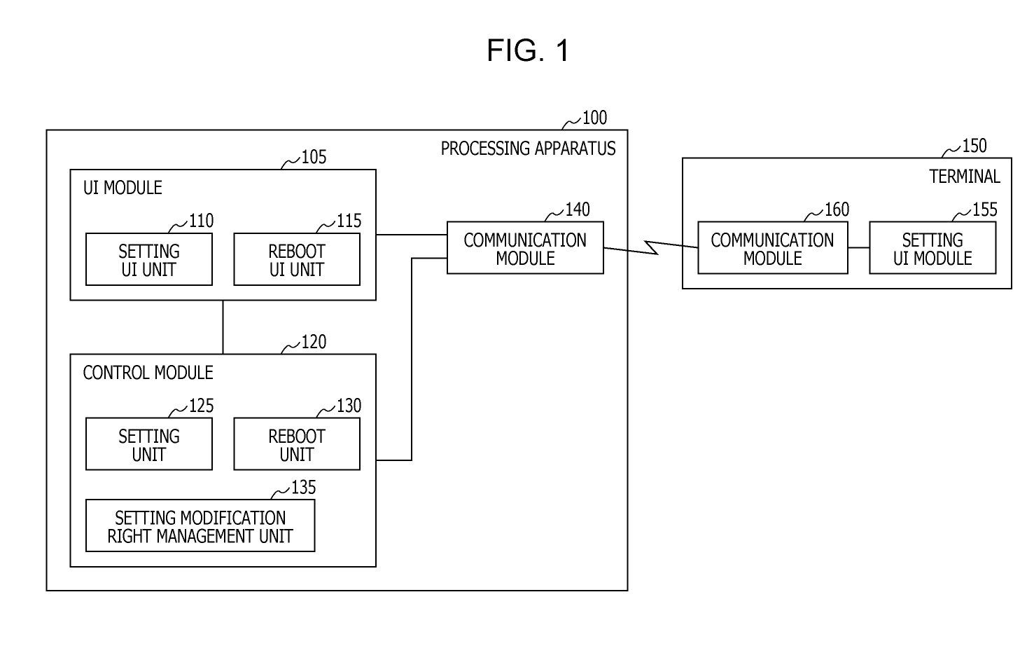

FIG. 1 illustrates a module concept of the exemplary embodiment.

The term module refers to a software component that is logically separable (a computer program), or a hardware component. The module of the exemplary embodiment refers to not only a module in a computer program but also a module in a hardware configuration. The discussion of the exemplary embodiment also serves as the discussion of computer programs for causing the modules to function (including a program that causes a computer to execute each step, a program that causes the computer to function as an element, and a program that causes the computer to implement each functionality), a system and a method. In the discussion that follows, the phrases “stores information,” “causes information to be stored,” and other phrases equivalent thereto are used. If the exemplary embodiment is a computer program, these phrases are intended to express “causes a memory device to store information” or “controls a memory device to cause the memory device to store information.” The modules may correspond to the functionalities in a one-to-one correspondence. In software implementation, one module may be composed of one program or multiple modules may be composed of one program. One module may be composed of multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the exemplary embodiment. Even after a process in the exemplary embodiment has started, the term “predetermined” refers to something that is decided in advance of a process of interest depending on a condition or a status of the exemplary embodiment at the present point of time or depending on a condition or status of the exemplary embodiment heretofore continuing down to the present point of time. If “predetermined values” are plural, the predetermined values may be different from each other, or two or more of the predetermined values (including all the values) may be equal to each other. A statement that “if A, B is to be performed” is intended to mean that it is determined whether something is A, and that if something is determined as A, an action B is to be taken. The statement becomes meaningless if the determination as to whether something is A is not performed.

The term “system” and the term “apparatus” refer to an arrangement where multiple computers, a hardware configuration, and an apparatus are interconnected via a communication network (including a one-to-one communication connection). The term “system” and the term “apparatus” also refer to an arrangement that includes a single computer, a hardware configuration, and an apparatus. The term “system” and the term “apparatus” have the same definition and are interchangeable with each other. The system in the context of the exemplary embodiment does not include a social system that is a social arrangement formulated by humans.

In each process performed by a module, or in one of the processes performed in a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a RAM (random-access memory), an external storage medium, a memory device connected via a communication network, and a register within a CPU (central processing unit).

In a processing apparatus 100 and a terminal 150 of the exemplary embodiment, a setting item on the processing apparatus 100 is modified in response to an instruction from the terminal 150. As illustrated in FIG. 1, the processing apparatus 100 is connected to the terminal 150 via a communication network. The word “setting” and the word “modification” are used in the same meaning. The word “modification” is thus intended to mean not only that “a value set in a setting item is modified” but also that “a new value is set in the setting item”. The word “setting” is intended to mean not only that “a new value is set in the setting item”, but also that “a value set in the setting item is modified”.

The processing apparatus 100 includes a user interface (UI) module 105, a control module 120, and a communication module 140. The processing apparatus 100 has a setting item for which the terminal 150 is designed to modify a value. The processing apparatus 100 may be one of image processing apparatuses including a copying machine, a facsimile machine, a scanner, a printer, a multi-function apparatus (like an image processing apparatus having at least two functionalities of the scanner, the printer, the copying machine, and the facsimile machine). The processing apparatus 100 may also be one of an information home appliance and a robot.

In the case of the image processing apparatus, the “setting items” may include restricting users to those who are permitted to print, setting an initial value for paper sheets in use, an initial value for color or monochrome printing, setting notification of a state of expendable items, and setting a time period before shifting to a power-saving mode. In the case of the information home appliance, the setting items may include temperature setting, and time setting for automatic power on/off. The values in the setting items may be a numerical value or information indicating yes or no.

A person who is authorized to “modify a value in a setting item” (or the terminal 150) may be anyone (or any terminal 150), or may be limited to a predetermined administrator (or a predetermined terminal 150).

The communication module 140 is connected to the UI module 105 and the control module 120 and is also connected to a communication module 160 in the terminal 150 via a communication network. The communication module 140 receives an instruction to modify a setting from the terminal 150, and transmits a web page or the like, which serves as a user interface used to modify a value in a setting item.

The UI module 105 includes a setting UI unit 110, and a reboot UI unit 115, and is connected to the control module 120 and the communication module 140. The UI module 105 provides a user interface to operate the processing apparatus 100. For example, the UI module 105 receives an operation performed by a user and presents a message to the user by controlling a liquid-crystal display that also serves as a touchpanel. The UI module 105 may further receive an operation by the user who uses a mouse, a keyboard, a camera, a microphone, or the like (the operation including a look, a gesture, and a voice). A message is presented to the user using an audio output from a speaker, or a tactile sensation from a haptic device.

The setting UI unit 110 receives an instruction to modify a value in a setting item in response to an operation performed by the user, using the user interface of the processing apparatus 100 (such as a button, a touchpanel, or the like). The setting UI unit 110 may provide to the terminal 150 a web page that receives an instruction to modify a value in a setting item. The modifications of the values in the setting items include a modification that is free from rebooting the processing apparatus 100 and a modification that involves rebooting the processing apparatus 100.

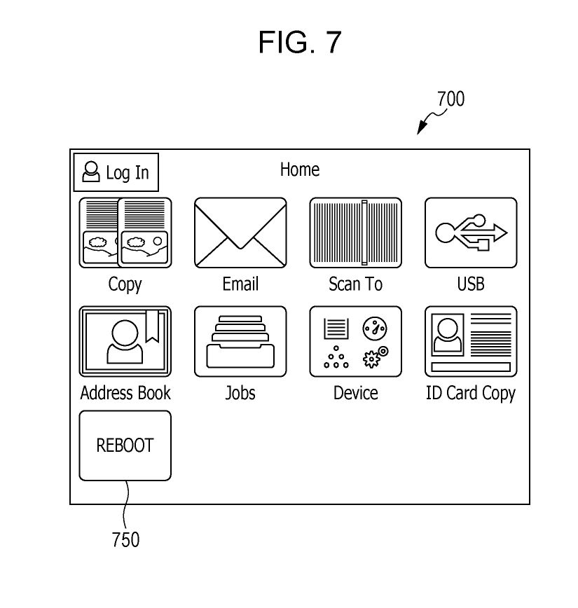

The processing apparatus 100 may be rebooted to reflect a modification of the value in the setting item on the processing apparatus 100. In this case, when the reboot UI unit 115 receives via the communication network from the terminal 150 information indicating a right to reboot, the reboot UI unit 115 presents an indication that a reboot is to be performed. The “presentation” includes presenting to the user a message (indicating that a reboot is to be performed), including presenting a display on a display unit in the processing apparatus 100, outputting an audio signal to an audio output device, such as a speaker, providing a tactile sensation using a haptic device, or performing a combination of these presentation operations. For example, the presentation may be a reboot request button 750 in a screen 700 as described below with reference to FIG. 7.

The modification of the value in the setting item that involves rebooting may be related to a communication basic setting of the processing apparatus 100, and a whole process setting of the processing apparatus 100. More specifically, the modification may be related to a change of IP address, a setting of net information of a secure socket layer (SSL), and a changing between the millimeter system and the inch system. Even if these values in the setting items are modified but the processing apparatus 100 is not rebooted, these values are not reflected and the processing apparatus 100 is unstable.

The “information indicating the right to reboot” may be received via the communication network from the terminal 150 that has issued an instruction to reflect the value in the setting item on the processing apparatus 100.

The “information indicating the right to reboot” indicates the right to exclusively reboot the processing apparatus 100. Without having the “information indicating the right to reboot”, the processing apparatus 100 is not able to be rebooted.

The terminal 150 having obtained the “information indicating the right to reboot” may transfer the “information indicating the right to reboot” to the processing apparatus 100. In such a case, both the terminal 150 and the processing apparatus 100 may reboot the processing apparatus 100. If a malfunction occurs as a result of a disconnection of the communication network while the terminal 150 modifies value in plural setting items, the terminal 150 is unable to reboot the processing apparatus 100 and the processing apparatus 100 is unstable. The above arrangement controls such an occurrence. Not only in such a malfunction, but also when the terminal 150 does not reboot the processing apparatus 100 (for example, the user of the processing apparatus 100 forgets or fails to issue an instruction to reboot), the indication that a reboot is to be performed is presented such that the processing apparatus 100 is reliably rebooted. The UI module 105 is not able to transfer the “information indicating the right to reboot” to another UI module 105.

Second information indicating the right to exclusively modify a value in a setting item (hereinafter also referred to as an exclusive setting right identification (ID)) may be used as the “information indicating the right to reboot”. In other words, the “information indicating the right to reboot” may be generated separately from the second information, or the “second information indicating the right to exclusively modify a value in a setting item” may be used as the “information indicating the right to reboot”. If the “second information indicating the right to exclusively modify a value in a setting item” also serves as the “information indicating the right to reboot”, the second information has a functionality for the “information indicating the right to exclusively modify the value in the setting item” and a functionality for the “information indicating the right to reboot”. In the following example, the second information has both functionalities.

If a process corresponding to an operation performed by the user does not use a value in a setting item, the reboot UI unit 115 may not necessarily have to present the indication that a reboot is to be performed.

If the process corresponding to the operation performed by the user uses the value in the setting item, the reboot UI unit 115 may present the indication that a reboot is to be performed.

The control module 120 includes a setting unit 125, a reboot unit 130, and a setting modification right management unit 135, and is connected to the UI module 105 and the communication module 140. The control module 120 performs an operation related to the updating of a value in a setting item. An instruction to update the value in the setting item may be received from the UI module 105, or from the terminal 150. Also, the control module 120 manages, more specifically, generates or deletes the “information indicating the right to reboot” and the second information. More specifically, the “information indicating the right to reboot” and the second information on the processing apparatus 100 are provided to a single terminal 150 (or the processing apparatus 100 corresponding to thereto). After the “information indicating the right to reboot” and the second information are generated, these pieces of information are not provided to the other terminals 150. When the “information indicating the right to reboot” and the second information are generated to exclusively modify the value in the setting item and to reboot the processing apparatus 100, the condition that the terminal 150 (or the processing apparatus 100) has the “information indicating the right to reboot” and the second information is to be satisfied. If the second information also serves as the “information indicating the right to reboot”, only the second information is managed. The “information indicating the right to reboot” is generated separately from the second information, the condition that the terminal 150 (or the processing apparatus 100) has the second information is to be satisfied.

Upon receiving a modification request to modify the value in the setting item and the second information, the setting unit 125 modifies the value in the setting item. The value in the setting item is not modified unless the modification request to modify the value in the setting item and the second information are received. In other words, the value in the setting item is modified only when the modification request to modify the value in the setting item and the second information are received. This is because the second information indicates the right to exclusively modify the value in the setting item.

The reboot unit 130 reboots the processing apparatus 100. The instruction to reboot is may be an instruction that the reboot UI unit 115 has received in response to an operation performed by a user who uses the processing apparatus 100 or in response to an operation performed by a user who uses the terminal 150.

The setting modification right management unit 135 manages the information indicating the right to reboot and the second information. For example, the setting modification right management unit 135 stores an exclusive setting right ID management table 500. FIG. 5A and FIG. 5B illustrate two examples of data structures of the exclusive setting right ID management tables 500. If the exclusive setting right ID management table 500 is simply quoted, it may be either an exclusive setting right ID management table 500A of FIG. 5A or an exclusive setting right ID management table 500B of FIG. 5B.

The exclusive setting right ID management table 500A of FIG. 5A includes an exclusive setting right ID column 510A. The exclusive setting right ID management table 500A lists an exclusive setting right ID only. In accordance with the exemplary embodiment, the exclusive setting right ID column 510A stores, as the second information, information uniquely identifying an exclusive setting right (exclusive setting right identification (ID)). If setting modification is performed only when the modification request to modify the value in the setting item and the exclusive setting right ID matching the stored exclusive setting right ID have been received, exclusive control may be performed regardless of the terminal.

The exclusive setting right ID management table 500B of FIG. 5B includes an exclusive setting right ID column 510B and a terminal ID column 520B. In accordance with the exemplary embodiment, the exclusive setting right ID column 510B stores information uniquely identifying an exclusive setting right as the second information (exclusive setting right ID). The terminal ID column 520B stores the ID of the terminal 150. More specifically, the terminal ID column 520B indicates that an apparatus having the right to modify a value in a setting item on the processing apparatus 100 is the terminal 150 with the ID thereof stored on the terminal ID column 520B. The terminal ID column 520B stores the ID of one terminal 150, and only that terminal 150 is able to modify a value in a setting item on the processing apparatus 100. A terminal 150 having no exclusive setting right ID is not able to modify a value in a setting item on the processing apparatus 100. The fact that the ID of the terminal 150 is not stored in the terminal ID column 520B may be interpreted to mean that the processing apparatus 100 has the right to modify a value in a setting item.

The terminal 150 includes a setting UI module 155 and communication module 160. The terminal 150 instructs a value in a setting item on the processing apparatus 100 to be modified, and may be a personal computer (such as a notebook personal computer (PC)), a portable information communication device (such as a mobile phone, a smart phone, a mobile device, or a wearable computer).

The communication module 160 is connected to the setting UI module 155, and is also connected to the communication module 140 in the processing apparatus 100 via the communication network. The communication module 160 transmits an instruction to modify setting to the processing apparatus 100, and then receives a web page that serves as a user interface that is used to modify a value in a setting item.

The setting UI module 155 is connected to the communication module 160. If the processing apparatus 100 is to rebooted to reflect the modification of a value in a setting item on the processing apparatus 100, the setting UI module 155 controls the communication module 160 to transmit, via the communication network, information indicating a right to reboot. For example, the setting UI module 155 may instruct the value in the setting item to be modified using the web page provided by the processing apparatus 100.

The setting UI module 155 may control the communication module 160 to transmit to the processing apparatus 100 the instruction to modify the value in the setting item and the second information indicating the right to exclusively modify the value in the setting item. In such a case, the setting UI module 155 may use the second information as the information indicating the right to reboot.

A determination as to whether an instruction is the instruction to modify the value in the setting item that involves rebooting the processing apparatus 100 may be performed by one of the processing apparatus 100 and the terminal 150 or by both the processing apparatus 100 and the terminal 150. In this determination method, the setting item involving rebooting may be stored in advance, and the determination is then made whether the instruction is related to that setting item.

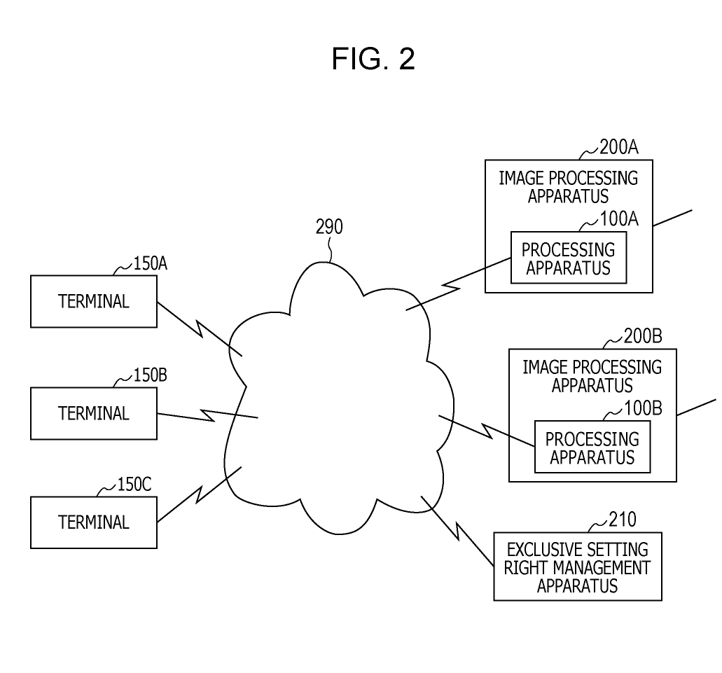

FIG. 2 illustrates a system configuration of the exemplary embodiment.

A terminal 150A, a terminal 150B, a terminal 150C, a processing apparatus 100A in an image processing apparatus 200A, a processing apparatus 100B in an image processing apparatus 200B, and an exclusive setting right management apparatus 210 are interconnected to each other via a communication network 290. The communication network 290 may be a wired line, a wireless line, or a combination thereof. For example, the communication network 290 may be the Internet, or an intranet as a communication infrastructure. The functionality of the exclusive setting right management apparatus 210 may be implemented as a cloud service. The image processing apparatus 200A includes the processing apparatus 100A. The image processing apparatus 200B includes the processing apparatus 100B.

To modify the value in the setting item on the image processing apparatus 200, the terminal 150 transmits to the processing apparatus 100 the instruction to modify the value in the setting item together with the second information. The processing apparatus 100 modifies the value in the setting item on condition that the second information is attached to the instruction. If the processing apparatus 100 is to be rebooted to reflect the modification of the value in the setting item on the processing apparatus 100, the terminal 150 transfers the second information to the processing apparatus 100. The processing apparatus 100 presents an indication that a reboot is to be performed. The user of the processing apparatus 100 reboots the processing apparatus 100 to reflect the modification of the value in the setting item.

The second information may be managed by the processing apparatus 100 or the exclusive setting right management apparatus 210. If the exclusive setting right management apparatus 210 manages the second information, the second information is managed on each of multiple processing apparatuses 100. For example, the exclusive setting right management apparatus 210 uses an exclusive setting right ID management table 1000. FIG. 10 illustrates an example of a data structure of the exclusive setting right ID management table 1000. The exclusive setting right ID management table 1000 includes a processing apparatus ID column 1010, an exclusive setting right ID column 1020, and a terminal ID column 1030. The processing apparatus ID column 1010 stores the ID of a processing apparatus 100. The exclusive setting right ID column 1020 stores an exclusive setting right ID. The terminal ID column 1030 stores the ID of a terminal 150. The exclusive setting right ID management table 1000 is formed by adding the processing apparatus ID column 1010 to the exclusive setting right ID management table 500B. The exclusive setting right ID is managed on each processing apparatus 100 in this way.

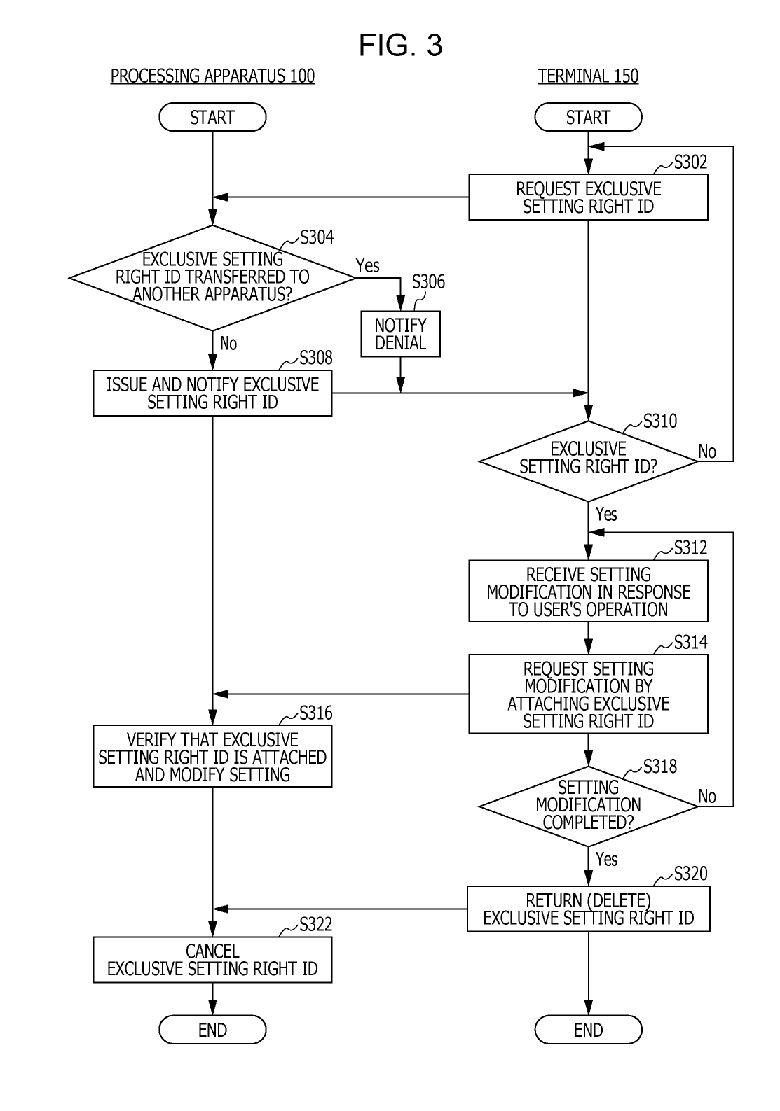

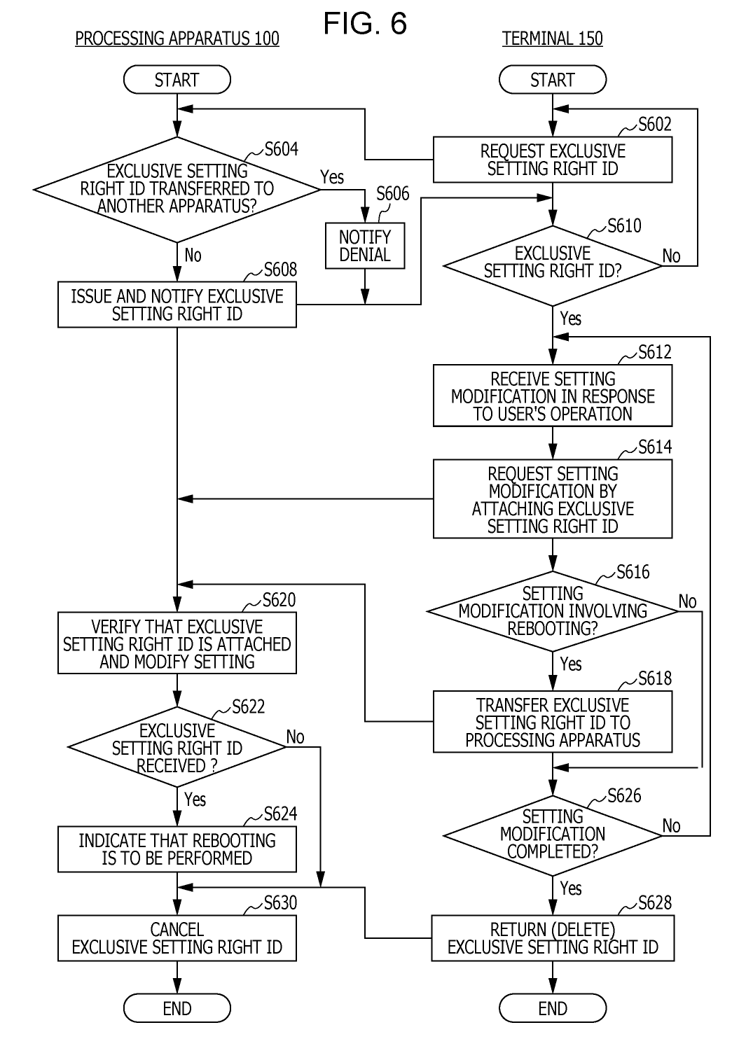

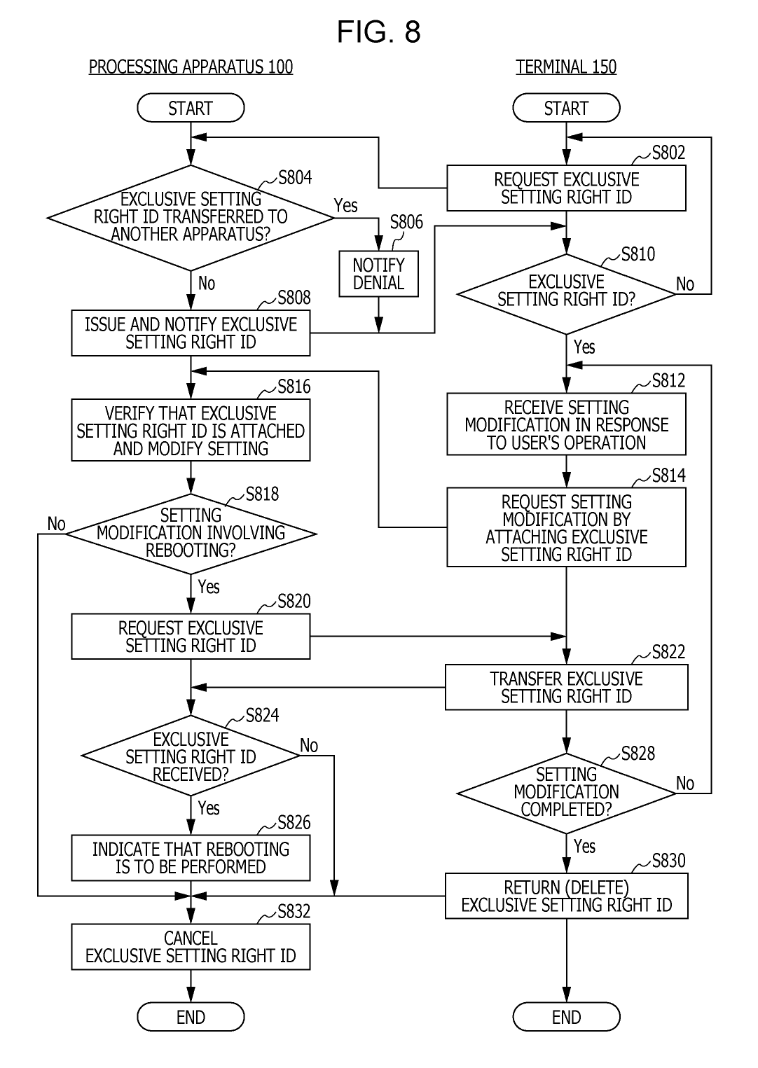

FIG. 3 is a flowchart illustrating a process example of the exemplary embodiment. FIG. 3 illustrates a modification process of the value in the setting item performed by the terminal 150 and the processing apparatus 100. A process that involves rebooting the processing apparatus 100 to reflect the modification of the value in the setting item on the processing apparatus 100 is described below with reference to FIG. 6 and FIG. 8.

In step S302, the terminal 150 requests an exclusive setting right ID (corresponding to the second information) from the processing apparatus 100. The terminal 150 obtains the exclusive setting right ID to modify a value in the setting item.

In step S304, the processing apparatus 100 determines whether the exclusive setting right ID has been transferred to another a terminal 150, and proceeds to step S306 if the exclusive setting right ID has been transferred to another terminal 150; otherwise, the processing apparatus 100 proceeds to step S308.

In step S306, the processing apparatus 100 notifies the UI module 105 of denial. The word “denial” is intended to mean that the terminal 150 of interest is unable to modify the value in the setting item since another terminal 150 is trying to modify a value in a setting item.

In step S308, the processing apparatus 100 issues and notifies the exclusive setting right ID to the terminal 150.

In step S310, the terminal 150 determines whether the exclusive setting right ID has been obtained. If the terminal 150 determines that the exclusive setting right ID has been obtained, processing proceeds to step S312; otherwise, the terminal 150 returns to step S302.

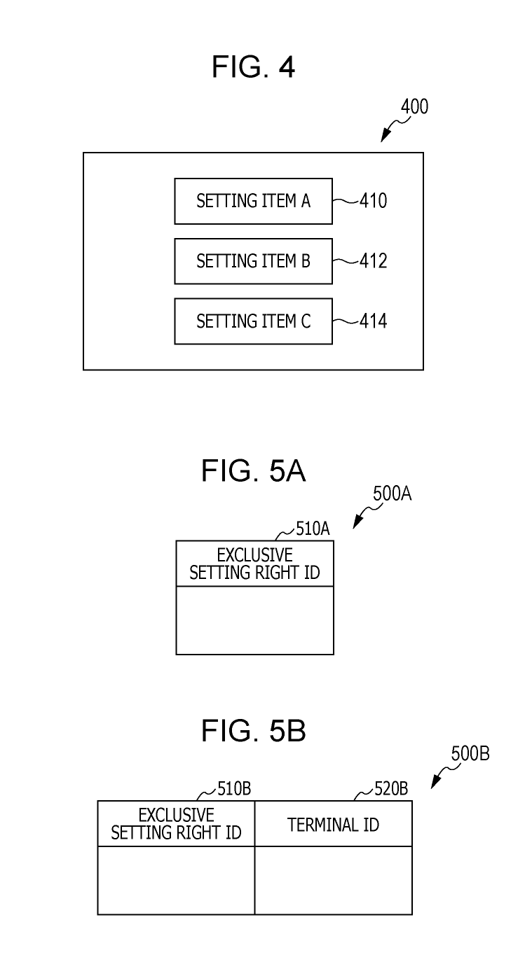

In step S312, the terminal 150 receives a setting modification responsive to an operation performed by the user. As illustrated in FIG. 4, for example, a setting item A button 410, the terminal 150 displays a setting item B button 412, and a setting item C button 414 on a setting screen 400, and receives an operation to modify a value in a setting item on the processing apparatus 100. The screen configuration of the setting screen 400 may be a web page received from the processing apparatus 100.

In step S314, the terminal 150 requests the processing apparatus 100 to perform a setting modification by attaching an exclusive setting right ID. The exclusive setting right ID is used to modify the value in the setting item.

In step S316, the processing apparatus 100 performs the setting modification after verifying that the exclusive setting right ID is attached. As previously described, the processing apparatus 100 uses the exclusive setting right ID management table 500 to determine whether the terminal 150 has the exclusive setting right ID.

In step S318, the terminal 150 determines whether the setting modification has been completed. If the setting modification has been completed, processing proceeds to step S320; otherwise, processing returns to step S312 since there is a possibility that plural setting items are to be modified.

In step S320, the terminal 150 returns the exclusive setting right ID to the processing apparatus 100. The terminal 150 then deletes the exclusive setting right ID.

In step S322, the processing apparatus 100 cancels the exclusive setting right ID. More specifically, the processing apparatus 100 deletes the exclusive setting right ID (or a row including the exclusive setting right ID) from the exclusive setting right ID management table 500.

FIG. 6 is a flowchart illustrating a process example of the exemplary embodiment. The process is performed to reboot the processing apparatus 100 to reflect the modification of the value in the setting item on the processing apparatus 100. In the process, the terminal 150 determines whether the processing apparatus 100 is to be rebooted. Operations in steps S602 through S614 are respectively identical to the operations in steps S302 through S314 of the flowchart of FIG. 3. Operations in steps S626 through S630 are respectively identical to the operations in steps S318 through S322 of the flowchart of FIG. 3.

In step S602, the terminal 150 requests the exclusive setting right ID from the processing apparatus 100.

In step S604, the processing apparatus 100 determines whether the exclusive setting right ID has been transferred to the terminal 150. If the exclusive setting right ID has been transferred to the terminal 150, processing proceeds to step S606; otherwise, processing proceeds to step S608.

In step S606, the processing apparatus 100 notifies the UI module 105 of denial.

In step S608, the processing apparatus 100 issues and notifies an exclusive setting right ID to the terminal 150.

In step S610, the terminal 150 determines whether the exclusive setting right ID has been obtained. If the exclusive setting right ID has been obtained, processing proceeds to step S612; otherwise, processing returns to step S602. If the UI module 105 obtains the exclusive setting right ID, the UI module 105 is able modify a value in a setting item on the processing apparatus 100, and has the right to reboot.

In step S612, the terminal 150 receives a setting modification in response to an operation performed by the user.

In step S614, the terminal 150 attaches the exclusive setting right ID and requests the setting modification from the processing apparatus 100.

In step S616, the terminal 150 determines whether the setting modification involves rebooting. If the setting modification involves rebooting, processing proceeds to step S618; otherwise, processing proceeds to step S626. For example, from among the setting items on the processing apparatus 100, setting items that involves rebooting the processing apparatus 100 are stored in advance to reflect the modification of the values in the setting items on the processing apparatus 100, and the terminal 150 may determines whether a setting item that the user is to modify matches a stored setting item.

In step S618, the terminal 150 transfers the exclusive setting right ID to the processing apparatus 100. The sentence “the terminal 150 ‘transfers the exclusive setting right ID’” is intended to mean that the terminal 150 still has the exclusive setting right ID while the processing apparatus 100 also obtains the exclusive setting right ID. Both the terminal 150 and the processing apparatus 100 may thus modify a value in a setting item on the processing apparatus 100. Each of the terminal 150 and the processing apparatus 100 may reboot the processing apparatus 100.

In step S620, the processing apparatus 100 performs the setting modification by verifying that the exclusive setting right ID is attached. In the process of FIG. 6, the operation in step S620 is performed subsequent to the operation in step S618. It is sufficient enough if the operation in step S620 is performed subsequent to the operation in step S614. The operation in step S620 may be performed prior to the operation in step S618.

In step S622, the processing apparatus 100 determines whether the processing apparatus 100 has received the exclusive setting right ID from the terminal 150. If the processing apparatus 100 has received the exclusive setting right ID, processing proceeds to step S624; otherwise, processing proceeds to step S630.

In step S624, the processing apparatus 100 presents an indication that a reboot is to be performed. Referring to FIG. 7, a reboot request button 750 is displayed on a screen 700 that has a copy button and the like as illustrated in FIG. 7. The reboot request button 750 is identified by a “REBOOT” label. Alternatively, the reboot request button 750 may be designed to be larger in size than other buttons, to blink, to be displayed in an overlaid fashion on another button, or to be displayed together with an alarm sound emitted. In the process of FIG. 6, an indication of the necessity for rebooting in step S628 is presented each time the value in the setting item is modified. Alternatively, the indication of the necessity for rebooting may be presented each time the end of the instruction to modify the value in the setting item is detected. For example, the indication of the necessity for rebooting may be presented subsequent to receiving a notification in step S628. Alternatively, to respond to the occurrence of a malfunction, such as a disconnection of the communication network with the terminal 150, the indication of the necessity for rebooting may be presented when a predetermined period of time has elapsed since the operation in step S620.

In step S626, the terminal 150 determines whether the setting modification has been completed or not. If the setting modification has been completed, processing proceeds to step S628; otherwise, processing returns to step S612.

In step S628, the terminal 150 returns the exclusive setting right ID to the processing apparatus 100. More specifically, the terminal 150 deletes the exclusive setting right ID. Prior to the operation in step S628, the instruction to reboot the processing apparatus 100 may be transmitted. If all the setting modifications are complete, and a malfunction, such as a disconnection of the communication network, does not occur, the terminal 150 may reboot the processing apparatus 100 as described in the Related Art section. This is because the terminal 150 has the exclusive setting right ID indicating the right to reboot. Naturally, the terminal 150 may not have to reboot the processing apparatus 100, and the operation in step S630 makes sure that the processing apparatus 100 is to be rebooted.

In step S630, the processing apparatus 100 cancels the exclusive setting right ID.

FIG. 8 is a flowchart illustrating a process example of the exemplary embodiment. The process of FIG. 8 is performed when the processing apparatus 100 is rebooted to reflect the modification of a value in a setting item. In the process, the processing apparatus 100 determines whether the processing apparatus 100 is to be rebooted. Operations in steps S802 through S816 are respectively identical to the operations in step S302 through S316 in the flowchart of FIG. 3. Operations in steps S824 through S832 are respectively identical to the operations in steps S622 through S630 in the flowchart of FIG. 6.

In step S802, the terminal 150 requests the exclusive setting right ID from the processing apparatus 100.

In step S804, the processing apparatus 100 determines whether the exclusive setting right ID has been transferred to the terminal 150. If the exclusive setting right ID has been transferred to the terminal 150, processing proceeds to step S806; otherwise, processing proceeds to step S808.

In step S806, the processing apparatus 100 notifies the terminal 150 of denial.

In step S808, the processing apparatus 100 issues and notifies an exclusive setting right ID to the terminal 150.

In step S810, the terminal 150 determines whether the terminal 150 has obtained the exclusive setting right ID. If the terminal 150 has obtained the exclusive setting right ID, processing proceeds to step S812; otherwise, processing returns to step S802.

In step S812, the terminal 150 receives the setting modification responsive to the user's operation.

In step S814, the terminal 150 attaches the exclusive setting right ID to the setting modification and requests the processing apparatus 100 to perform the setting modification.

In step S816, the processing apparatus 100 verifies that the exclusive setting right ID has been attached, and then performs the setting modification.

In step S818, the processing apparatus 100 determines whether the setting modification involves rebooting the processing apparatus 100. If the setting modification involves rebooting the processing apparatus 100, processing proceeds to step S820; otherwise, processing proceeds to step S832. For example, from among the setting items on the processing apparatus 100, a setting item that involves rebooting the processing apparatus 100 to reflect the modification of the value in the setting item is stored in advance, and a determination is made as to whether the setting item of the request from the terminal 150 matches the stored setting item.

In step S820, the processing apparatus 100 requests the exclusive setting right ID from the terminal 150 to reboot the processing apparatus 100. If a modification of values in plural setting items is performed, the operation in step S820 is performed for the first routine only.

In step S822, the terminal 150 transfers the exclusive setting right ID to the processing apparatus 100. Since the terminal 150 does not determine whether the setting modification involves rebooting, the terminal 150 waits for the request of the processing apparatus 100 in step S820 and then performs the operation in step S822.

In step S824, the processing apparatus 100 determines whether the exclusive setting right ID has been received from the terminal 150. If the exclusive setting right ID has been received, processing proceeds to step S826; otherwise, processing proceeds to step S832.

In step S826, the processing apparatus 100 presents an indication that a reboot is to be performed.

In step S828, the terminal 150 determines whether the setting modification has been completed. If the setting modification has been completed, processing proceeds to step S830; otherwise, processing returns to step S812.

In step S830, the terminal 150 returns the exclusive setting right ID to the processing apparatus 100. More specifically, the terminal 150 deletes the exclusive setting right ID thereof.

In step S832, the processing apparatus 100 cancels the exclusive setting right ID.

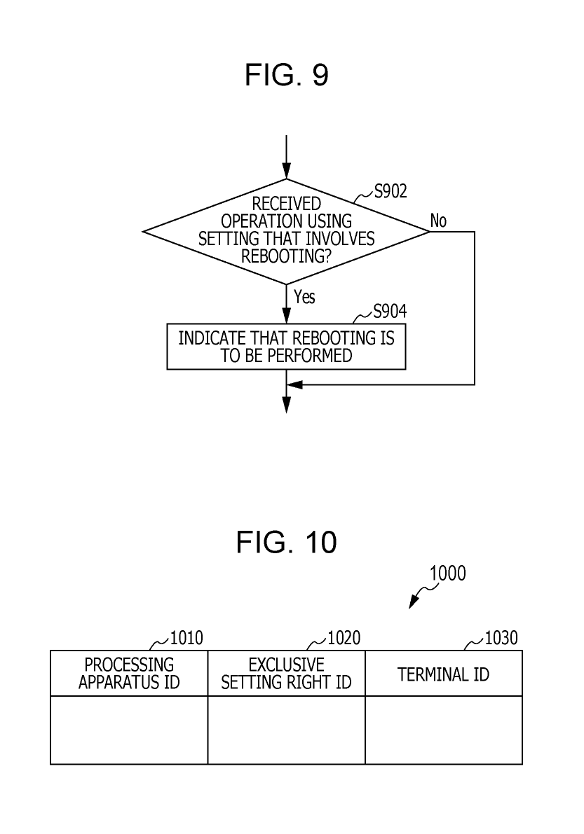

FIG. 9 is a flowchart illustrating a process example of the exemplary embodiment.

The operation in step S622 of FIG. 6 or the operation in step S824 of FIG. 8 may be used as an operation in step S902 of FIG. 9. More specifically, the flowcharts of FIG. 6 and FIG. 8 indicate that a reboot is to be performed when the exclusive setting right has transferred. However, the rebooting does not have to be performed until an operation to use the setting item that is reflected through the rebooting is performed, and the indication that a reboot is to be performed immediately prior to the operation to use the setting item (user's operation) is thus presented. For example, an IP address may now be changed to another, and a copying operation may also be performed. In such a case, since the copying operation is not related to the change of IP addresses, the copying operation is performed alone. If an operation that uses the communication network (for example, transferring a scanned image to the PC of the user) is selected, the indication that a reboot is to be performed is presented.

In step S902, the processing apparatus 100 determines whether a received operation (an operation performed on the processing apparatus 100 by the user) uses a setting item that involves the rebooting. If the received operation uses the setting item that involves the rebooting, processing proceeds to step S904; otherwise, processing proceeds to step S630 (step S832).

In step S904, the processing apparatus 100 presents the indication that the rebooting is to be performed. The user may recognize that the rebooting is to be performed prior the user's operation, and may then perform a reboot operation.

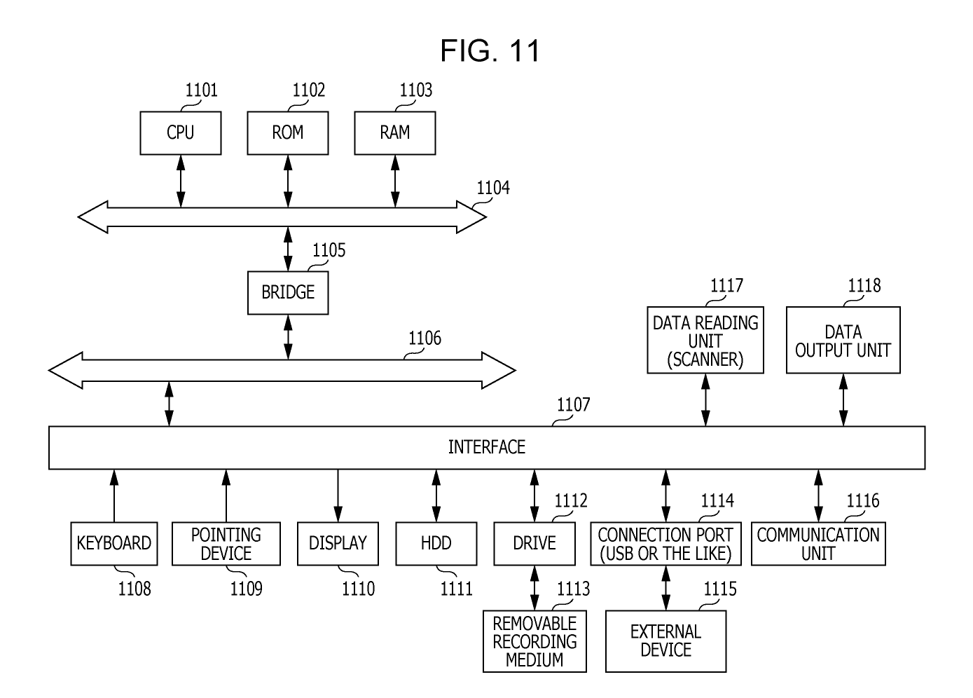

A hardware configuration of each of the processing apparatus 100 and the terminal 150 of the exemplary embodiment is described with reference to FIG. 11. The hardware configuration of FIG. 11 is implemented by a personal computer (PC), for example, and includes a data reading unit 1117, such as a scanner, and a data output unit 1118, such as printer.

A central processing unit (CPU) 1101 is a controller that performs processes in accordance with a computer program that describes an execution sequence of each of the modules described above. The modules include the UI module 105, the setting UI unit 110, the reboot UI unit 115, the control module 120, the setting unit 125, the reboot unit 130, the communication module 140, the communication module 160, and the setting UI module 155.

A read-only memory (ROM) 1102 stores a program and an arithmetic parameter used by the CPU 1101. A random-access memory (RAM) 1103 stores a program executed by the CPU 1101, or a parameter that changes as appropriate in the execution of the program. These memories are interconnected via a host bus 1104 including a CPU bus.

The host bus 1104 is connected to an external bus 1106, such as a peripheral component interconnect/interface (PCI) bus and the like, via a bridge 1105.

A keyboard 1108 and a pointing device 1109, such as a mouse, are devices that are operated by the user. A display 1110 may be a liquid-crystal display device or a cathode ray tube (CRT), and displays a variety of information as text or image information. Alternatively, a touch screen having the functionalities of both the pointing device 1109 and the display 1110 may be used. In such a case, the functionality of the keyboard is implemented by displaying a keyboard on a screen (touch screen) through software (this on-screen key board is referred to as a software keyboard or a screen keyboard) without physically connecting the keyboard 1108. The functionality of the keyboard is thus implemented.

A hard disk drive (HDD) 1111 including a hard disk (or a flash memory) drives a hard disk, and records or reproduces information and the program executed by the CPU 1101. The hard disk implements the functionality of the setting modification right management unit 135. The HDD 111 also stores another variety of data and a variety of computer programs.

A drive 1112 reads data or a program recorded on a loaded removable recording medium 1113, such as a magnetic disk, an optical disk, a magneto-optical disk, or a semiconductor memory, and then sends the data or program to the connected RAM 1103 via an interface 1107, external bus 1106, bridge 1105, and host bus 1104. The removable recording medium 1113 may also be used as a data recording region.

A connection port 1114 connects an external device 1115 to the PC, and includes a connection unit of a universal serial bus (USB), or IEEE 1394. The connection port 1114 is connected to the CPU 1101 and the like via the interface 1107, the external bus 1106, the bridge 1105, and the host bus 1104. The communication unit 1116 is connected to the communication network, and performs data communication with the outside. The data reading unit 1117 is a scanner, for example, and reads a document. The data output unit 1118 is a printer, for example, and performs an output operation on document data.

The hardware configuration of FIG. 11 for the processing apparatus 100 and the terminal 150 indicates a configuration example only. The exemplary embodiment is not limited to this hardware configuration of FIG. 11 and may be acceptable in any form as long as the modules of the exemplary embodiment are implemented. For example, some modules may be implemented using an application specific integrated circuit (ASIC) or the like. In another example, some modules may be in an external system and connected to the system of FIG. 11 via a communication network. In yet another example, plural systems of FIG. 11 may be interconnected to each other via a communication network such that the systems operate in concert with each other. One of the modules may be incorporated not only in a personal computer, but also in a portable information communication apparatus, an information home appliance, a robot, a copying machine, a facsimile device, a scanner, a printer, a multi-function apparatus.

The above-described program may be supplied in a stored state on a recording medium. The program may also be provided via communications. In such a case, the above-described program may be understood as an invention of the “non-transitory computer readable recording medium storing the program”.

The “non-transitory computer readable recording medium storing the program” refers to a computer readable recording medium storing the program, and is used to install the program, to execute the program, or to distribute the program.

The recording media include digital versatile disk (DVD), compact disk (CD), Blu-ray disk (registered trademark), magneto-optical disk (MO), flexible disk (FD), magnetic tape, hard disk, read-only memory (ROM), electronically erasable and programmable read-only memory (EEPROM (registered trademark)), flash memory, random-access memory (RAM), and secure digital (SD) memory card. The DVDs include “DVD-R, DVD-RW, and DVD-RAM”, each complying with the standard formulated by the DVD forum, and “DVD+R and DVD+RW” complying with DVD+RW standards. The CDs include read-only CD (CD-ROM), recordable CD-R, and rewritable CD-RW.

The program in whole or in part may be stored on the recording medium for storage and distribution. The program in whole or in part may be transmitted via a transfer medium. The transfer media include a wired network, a wireless network, or a combination thereof. The wired and wireless networks may include a local-area network (LAN), a metropolitan-area network (MAN), a wide-area network (WAN), the Internet, an intranet, and an extranet. The program in whole or in part may be transmitted over a carrier wave.

The program may be part or whole of another program, or may be stored on the recording medium together with another program. The program may be split and split programs may then be separately stored on the recording media. The program may be processed in any fashion before being stored as long as the program remains restorable. For example, the program may be compressed or encrypted before storage.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing apparatus comprising a presentation unit that presents an indication that a reboot is to be performed when information indicating a right to reboot is received via a communication network if the processing apparatus is to be rebooted to reflect a setting of a value in a setting item on the processing apparatus.

2. The processing apparatus according to claim 1, wherein the processing apparatus receives the information indicating the right to reboot via the communication network from an information processing apparatus that has instructed the value in the setting item to be reflected on the processing apparatus.

3. The processing apparatus according to claim 2, wherein the processing apparatus uses, as the information indicating the right to reboot, second information indicating a right to exclusively set the value in the setting item.

4. The processing apparatus according to claim 3, further comprising a setting unit that sets the value in the setting item if the value in the setting item and the second information are received.

5. The processing apparatus according to claim 1, wherein the presentation unit does not present the indication if a process responsive to an operation performed by a user does not use the value in the setting item.

6. The processing apparatus according to claim 1, wherein the presentation unit presents the indication if a process responsive to an operation performed by a user uses the value in the setting item.

7. An information processing apparatus comprising a first transmitting unit that transmits, via a communication network, information indicating a right to reboot if a processing apparatus is to be rebooted to reflect a setting of a value in a setting item on the processing apparatus.

8. The information processing apparatus according to claim 7, further comprising a second transmitting apparatus that transmits, to the processing apparatus, an instruction to set the value in the setting item and second information indicating a right to exclusively set the value in the setting item,
wherein the first transmitting unit uses the second information as the information indicating the right to reboot.

9. A processing system comprising:
an information processing apparatus including a transmitting unit that transmits, via a communication network, information indicating a right to reboot if a processing apparatus is to be rebooted to reflect a setting of a value in a setting item on the processing apparatus; and
a processing apparatus including a presentation unit that presents an indication that a reboot is to be performed if the information indicating the right to reboot is received via the communication network.
